(19) United States
(12) Patent Application Publication
(10) Pub. No.: US 2007/0154743 A1
(43) Pub. Date: Jul. 5, 2007

(54) Micro-energy re-activating method to recover PEM fuel cell performance

(76) Inventors: Ruiming Zhang, Urbana, IL (US); Zakia Khan, Champaign, IL (US); Brian Adams, Port Moody (CA); Wai Lung Law, Port Coqvtlam (CA); Alison Hack, Surrey (CA); Yinghul Pan, Champaign, IL (US)

Correspondence Address: MCANDREWS HELD & MALLOY, LTD, 500 WEST MADISON STREET, SUITE 3400, CHICAGO, IL, 60661, US

(21) Appl. No.: 11/323,678

(22) Filed: Dec. 30, 2005

(51) Int. Cl. H01M 8/04

(52) U.S. Cl. 429/13; 429/22

(57) ABSTRACT

A method and system for counteracting performance deterioration in an electrochemical fuel cell includes passive re-activation, active re-activation, or both. Active re-activation includes intermittently applying positive voltage electrical pulse across the anode. The positive voltage applied is less than that required for decomposition of water. Passive re-activation includes interposing a resistive load between the anode and the cathode while fuel stream flow to the anode is interrupted. The resistive load increases voltage potential at the anode to less than that required for oxidation of carbon.

### FIELD OF THE INVENTION

The present invention relates to active and passive re-activation of fuel cells to recover performance. The present invention further relates to active re-activation of fuel cells by applying a series of positive pulses to the anode of the fuel cell, and also to passive re-activation of fuel cells by controlling the load level between the anode and the cathode when the fuel cell is near fuel interruption. The pulse width, frequency, voltage, current and fuel status can be controlled to achieve high re-activation efficiency and to reduce negative impact to the fuel cell.

### BACKGROUND OF INVENTION

Fuel cells are electrochemical cells in which a free energy change resulting from a fuel oxidation reaction is converted into electrical energy. Applications for fuel cells include battery replacement; mini—and microelectronics such as portable electronic devices; sensors such as gas detectors, seismic sensors, and infrared sensors; electromechanical devices; automotive engines and other transportation power generators; power plants, and many others. One advantage of fuel cells is that they are substantially pollution-free.

Electrochemical fuel cells convert fuel and oxidant fluid streams to electricity and reaction product. Solid polymer electrochemical fuel cells generally employ a membrane electrode assembly (MEA) comprising a solid polymer electrolyte or ion-exchange membrane disposed between two porous electrically conductive electrode layers. An electrocatalyst is typically disposed at each membrane/electrode layer interface to induce the desired electrochemical reaction.

The electrode substrate typically comprises a sheet of porous, electrically conductive material, such as carbon fiber paper or carbon cloth. The layer of electrocatalyst is typically in the form of finely comminuted metal, such as platinum, palladium, or ruthenium, and is disposed on the surface of the electrode substrate at the interface with the membrane electrolyte in order to induce the desired electrochemical reaction. In a single cell, the electrodes are electrically coupled to provide a path for conducting electrons between the electrodes through an external load.

The fuel stream directed to the anode by a fuel flow field migrates through the porous anode and is oxidized at the anode electrocatalyst layer. The oxidant stream directed to the cathode by an oxidant flow field migrates through the porous cathode and is reduced at the cathode electrocatalyst layer.

Electrochemical fuel cells can employ gaseous fuels and oxidants, for example, those operating with molecular hydrogen as the fuel and oxygen in air or a carrier gas (or substantially pure oxygen) as the oxidant. In hydrogen fuel cells, hydrogen gas is oxidized to form water, with a useful electrical current produced as a byproduct of the oxidation reaction. A solid polymer membrane electrolyte layer can be employed to separate the hydrogen fuel from the oxygen. The anode and cathode are arranged on opposite faces of the membrane. Electron flow along the electrical connection between the anode and the cathode provides electrical power to load(s) interposed in circuit with the electrical connection between the anode and the cathode. The anode and cathode reactions in hydrogen/oxygen fuel cells are shown in the following equations:
H₂→2H⁺+2e− Anode reaction
½O₂+2H⁺+2e⁻→H₂O Cathode reaction

The catalyzed reaction at the anode produces hydrogen cations (protons) from the fuel supply. The ion-exchange membrane facilitates the migration of protons from the anode to the cathode. In addition to conducting protons, the membrane isolates the hydrogen-containing gaseous fuel stream from the oxygen-containing gaseous oxidant stream. At the cathode electrocatalyst layer, oxygen reacts with the protons that have crossed the membrane to form water as the reaction product. Hydrogen fuel cells are impractical for many applications, however, because of difficulties related to storing and handling hydrogen gas.

Organic fuel cells may prove useful in many applications as an alternative to hydrogen fuel cells. In an organic fuel cell, an organic fuel such as methanol or formic acid is oxidized to carbon dioxide at an anode, while air or oxygen is simultaneously reduced to water at a cathode. One advantage over hydrogen fuel cells is that organic/air fuel cells can be operated with a liquid organic fuel. This diminishes or eliminates problems associated with hydrogen gas handling and storage. Some organic fuel cells require initial conversion of the organic fuel to hydrogen gas by a reformer. These are referred to as “indirect” fuel cells. A reformer increases cell size, cost, complexity, and start up time. Other types of organic fuel cells, called “direct,” operate without a reformer by directly oxidizing the organic fuel without conversion to hydrogen gas. To date, fuels employed in direct organic fuel cell development include methanol and other alcohols, as well as formic acid and other simple acids.

In direct liquid feed fuel cells, the reaction at the anode produces protons, as in the hydrogen/oxygen fuel cell described above. The protons (along with carbon dioxide) result from the oxidation of the organic fuel, such as formic acid. An electrocatalyst promotes the organic fuel oxidation at the anode. The organic fuel can alternatively be supplied to the anode as vapor, but it is generally advantageous to supply the organic fuel to the anode as a liquid, preferably as an aqueous solution. The anode and cathode reactions in a direct formic acid fuel cell are shown in the following equations:
HCOOH+→2H⁺+CO₂+2^{e-} Anode reaction
O₂+2H⁺+2e⁻→2H₂O Cathode reaction
HCOOH+O₂→CO₂+2H₂O Overall reaction

The protons formed at the anode electrocatalyst migrate through the ion-exchange membrane from the anode to the cathode, and at the cathode electrocatalyst layer, the oxidant reacts with the protons to form water.

One obstacle to the widespread commercialization of direct fuel cell technology is the exhaustion of fuel cells. Fuel cells can become exhausted due to the accumulation of poisonous species, particularly carbon monoxide, on the anode. Fuel cells can also become exhausted due to the formation of oxides at the cathode. For example, if a platinum catalyst is employed on the cathode, some of the platinum can be oxidized to form platinum oxides. The oxidation of the cathode catalyst decreases the activity of the catalyst and therefore decreases the effectiveness of the fuel cell as a power source. Additionally, a fuel cell can become exhausted due to membrane dry-out.

One conventional approach for regenerating fuel cell performance is by using hydrogen evolution as described in He et al. U.S. Pat. No. 6,730,424.

Another approach is to vary the anode potential in a pulsed manner as described in Stimming et al. U.S. Patent Application Publication US2003/0022033A1.

A third approach is to periodically starve the anode of fuel, as described in Wilkinson et al. U.S. Pat. No. 6,096,448.

These conventional approaches, however, often require relatively high power consumption and/or relatively high fuel consumption. In addition, these approaches can cause flooding of the cathode with water and increase anode water loss. These approaches can also lead to corrosion of the anode. The conventional approaches for fuel cell re-activation have limitations that make them impractical under certain conditions. The approach described in U.S. Pat. No. 6,730,424 involves a major interruption in fuel cell output and is not suitable for continuous operation. The approach described in U.S. Patent Application Publication 2003/0022033A1 has high power requirements and reduces system efficiency, which can lead to excessive water build-up on the cathode. The approach described in U.S. Pat. No. 6,096,448 is intended for use in a large fuel cell unit. The conventional approaches may not remove the anode poisons completely because the anode potential cannot reach the high voltage in a short amount of time. In addition, these methods can involve the loss of significant amounts of fuel during re-activation, reducing system efficiency.

### SUMMARY OF THE INVENTION

One or more of the shortcomings of conventional methods and apparatuses for regenerating the performance of fuel cells are overcome by the present system and method for regenerating fuel cell performance while using relatively low power. In one embodiment, a method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at the anode, the method comprising:
(a) interrupting flow of the fuel stream to the anode;
(b) intermittently applying positive voltage electrical pulse across the anode, the positive voltage less than that required for decomposition of water; and
(c) interposing a resistive load between the anode and the cathode while fuel stream flow to the anode is interrupted, the resistive load increasing voltage potential at the anode to less than that required for oxidation of carbon.

In a preferred embodiment, the positive voltage electrical pulse is applied across the anode while fuel stream flow to the anode is interrupted. In another preferred embodiment, the positive voltage electrical pulse has a magnitude between about 0.9 V and about 1.5 V on the anode. In another preferred embodiment, the positive voltage electrical pulse has a current density associated therewith having a magnitude no greater than about 0.5 A/cm².

In a preferred embodiment, the positive voltage electrical pulse is applied at intervals of at least 0.1 seconds to 2 hours. In a more preferred embodiment, the positive voltage electrical pulse is applied at intervals of about 5 minutes. In a preferred embodiment, the positive voltage electrical pulse is applied for a duration of between 1 millisecond and 100 seconds. In a more preferred embodiment, the positive voltage electrical pulse is applied for a duration of between 0.5 seconds and 1.5 seconds. Most preferably, the positive voltage electrical pulse is applied at intervals of about 100 milliseconds and for a duration of about 5 milliseconds.

In a preferred embodiment, the positive voltage electrical pulse is derived from electrical power generated by the fuel cell.

In a preferred embodiment, the positive voltage electrical pulse has a positive voltage sufficient to oxidize carbon monoxide.

In a preferred embodiment, interposing the resistive load increases the anode potential to a voltage magnitude about equal to that of the cathode. In a preferred embodiment, interposing the resistive load decreases the cathode potential to a voltage magnitude about equal to that of the anode potential. In a preferred embodiment, the resistive load is between about 0 ohms (Ω) and about 1.5 Ω.

In a preferred embodiment, the fuel stream comprises formic acid.

In another embodiment, a method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at the anode, comprises intermittently applying positive voltage electrical pulse across the anode, the positive voltage less than that required for decomposition of water. In a preferred embodiment, the method comprises interrupting flow of the fuel stream to the anode, and applying the positive voltage pulse across the anode while fuel stream flow to the anode is interrupted.

In another embodiment, a method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at the anode, comprises:
(a) interrupting flow of the fuel stream to the anode; and
(b) interposing a resistive load between the anode and the cathode while fuel stream flow to the anode is interrupted, the resistive load increasing voltage potential at the anode to less than that required for oxidation of carbon.

In another embodiment, an electric power generation system comprises:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at the anode;
(c) a flow control mechanism capable of interrupting flow of the fuel stream to the anode;
(d) an electrical circuit capable of intermittently applying positive voltage electrical pulse across the anode, the positive voltage less than that required for decomposition of water; and
(e) a resistive load interposable between the anode and the cathode while fuel stream flow to the anode is interrupted, the resistive load increasing voltage potential at the anode to less than that required for oxidation of carbon.

In a preferred embodiment, the flow control mechanism is a valve. In another preferred embodiment, the electrical circuit is capable of intermittently applying positive voltage electrical pulse across the anode while the fuel stream flow to the anode is interrupted.

In another embodiment, an electric power generation system comprises:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at the anode;
(c) a flow control mechanism capable of interrupting flow of the fuel stream to the anode; and
(d) an electrical circuit capable of intermittently applying positive voltage electrical pulse across the anode while the fuel stream flow to the anode is interrupted, the positive voltage less than that required for decomposition of water.

In another embodiment, an electric power generation system comprises:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at the anode;
(c) a flow control mechanism capable of interrupting flow of the fuel stream to the anode; and
(d) a resistive load interposable between the anode and the cathode while fuel stream flow to the anode is interrupted, the resistive load increasing voltage potential at the anode to less than that required for oxidation of carbon.

### BRIEF DESCRIPTION OF THE DRAWINGS

FIG. 1 is a schematic of a fuel cell with an electronic system for re-activating anode catalyst layer in a fuel cell.

FIG. 2 is a process flow diagram illustrating steps for measuring and triggering an active re-activation process.

FIG. 3 is a graphical representation of a series of positive voltage pulses applied by the active electronic re-activating system. FIG. 3A shows long infrequent pulses. FIG. 3B shows short and frequent intense pulses. FIG. 3C shows a combination of long and short pulses.

FIG. 4 is a graph of cell voltage as a function of time, showing before and after active re-activation of the fuel cell anode, at A, the applied voltage pulses are above a preferred upper threshold and at B, the applied voltage pulses are below a preferred upper threshold.

FIG. 5 is a process flow diagram illustrating steps of a passive “shorting” re-activation process.

FIG. 6 shows a graph of cell voltage during fuel interruption and after passive re-activation of the fuel cell anode in a constant resistance mode.

FIG. 7 is a process flow diagram illustrating a control protocol for selecting a sequence of active or passive re-activation.

### DETAILED DESCRIPTION OF PREFERRED EMBODIMENT(S)

A method and system for re-activating a fuel cell membrane electrode assembly improves fuel cell performance, while reducing power consumption and at least some of the problems described previously.

Fuel cells generally have an anode and a cathode disposed on either side of an electrolyte. The anode and cathode generally comprise electrocatalyst, such as platinum, palladium, platinum-ruthenium alloys, other noble metals and/or metal alloys. The electrolyte usually comprises a proton exchange membrane (PEM), typically a perfluorosulfonic acid polymer membrane, of which Nafion® is a commercial brand (E.I. du Pont de Nemours and Company, Wilmington, Del., USA). At the anode, fuel is oxidized at the electrocatalyst to produce protons and electrons. Protons migrate through the proton exchange membrane to the cathode. At the cathode, the oxidant reacts with the protons. The electrons travel from the anode to the cathode through an external circuit, producing an electrical current.

Liquid feed electrochemical fuel cells can operate using various liquid reactants. For example, the fuel stream can be methanol in a direct methanol fuel cell, or formic acid fuel in a direct formic acid fuel cell (DFAFC). The oxidant can be substantially pure oxygen or a dilute stream such as air containing oxygen.

The fuel stream can contain impurities, which do not contribute to, and can inhibit, the desired electrochemical reaction. These impurities can, for example, originate from the fuel stream supply itself, or can be generated in the fuel cell as intermediate species during the fuel cell reactions. Further, impurities can enter the fuel stream from elsewhere in the system. Some of these impurities can be chemically adsorbed or physically deposited on the surface of the anode electrocatalyst, blocking the active electrocatalyst sites and preventing these portions of the anode electrocatalyst from inducing the desired electrochemical fuel oxidation reaction. Such impurities are known as electrocatalyst “poisons” and their effect on electrochemical fuel cells is known as “electrocatalyst poisoning.” Electrocatalyst poisoning thus results in reduced fuel cell performance, where fuel cell performance is defined as the voltage output from the cell for a given current density. Higher performance is associated with higher voltage for a given current density or higher current for a given voltage.

In the absence of countermeasures, the adsorption or deposition of electrocatalyst poisons can be cumulative, so even minute concentrations of poisons in a fuel stream, can, over time, result in a degree of electrocatalyst poisoning which is detrimental to fuel cell performance.

The embodiments will be described in detail with respect to direct formic acid fuel cells (DFAFC), with applicability to other liquid fuel cells such as methanol. In the case of direct formic acid fuel cells, the following electrochemical reactions at anode are possible:
CO+H₂O→CO₂+2H⁺ [1]
2H₂O→O₂+4H⁺+4e⁻(anode potential>1.5 V) [2]
HCOOH→CO₂+2H⁺+2e⁻ [3]

Reaction [1] is the oxidation of carbon monoxide from the anode and is desirable. Reaction [2] is the decomposition of water and is undesirable in a fuel cell. Reaction [3] is the consumption of fuel. Reaction [3] is desirable when running the fuel cell in normal operation, but is less desirable during re-activation because it consumes energy and can result in wasted fuel and inefficiency.

For the case of formic acid fuel cells, the poisoning species (CO) on the anode can be oxidized (removed) by increasing the anode potential by applying short positive voltage pulses. In order to make reaction [1] consume available CO, the anode potential should be greater than about 1 V. Additionally, the reaction rate of reaction [1] increases as the anode potential increases, so the desired range of anode voltage pulsing is approximately 1 V and higher for efficient re-activation in a short period of time.

If the anode potential is greater than about 1.5 V, however, undesirable reaction [2] occurs, which breaks down water to produce hydrogen at the cathode and oxygen at the anode. This reaction is undesirable as it consumes power without providing a re-activation benefit, and reduces the anode water content (potentially increasing the membrane dry-out and crossover risks). A preferred range for the positive anode pulses is above about 1 V and below 1.5 V.

A technique of applying pulsed anode potential is described in U.S. Patent Publication No. 2003/0022033, and is hereby incorporated herein by reference in its entirety. In the case of formic acid, delivering fuel while providing a positive anode potential can consume energy because of reaction [3]. The re-activating system and method is preferably activated when the cell is at near-fuel interruption condition (by controlling the fuel supply before the re-activating process) so reaction [3] is limited. Decreasing reactions [2] and [3] results in lower current and less water flux from the anode to the cathode is much less. Decreasing the water flux from the anode to the cathode helps to reduce cathode flooding. Water stays inside the membrane, thereby reducing the possible occurrence of membrane dry-out.

Carbon corrosion at the anode by formic acid can affect supporting or adjacent layers near the anode catalyst layer in addition to the anode. In particular, a preferred formic acid fuel cell system can include a graphite layer. The carbon corrosion reaction is:
C+2H₂O→CO₂+4H⁺+4e⁻(anode potential>1.4 V) [4]

The reaction rate of reaction [4] is lower than the reaction rate of reaction [1]. The different time scales allow for use of short pulses to enable reaction [1] but limit reaction [4]. The anode re-activation method and system employs a short-pulse method to avoid reaction [4] by controlling the pulse width. A series of positive pulses can encourage reaction [1] while reducing damage to anode carbon-based materials.

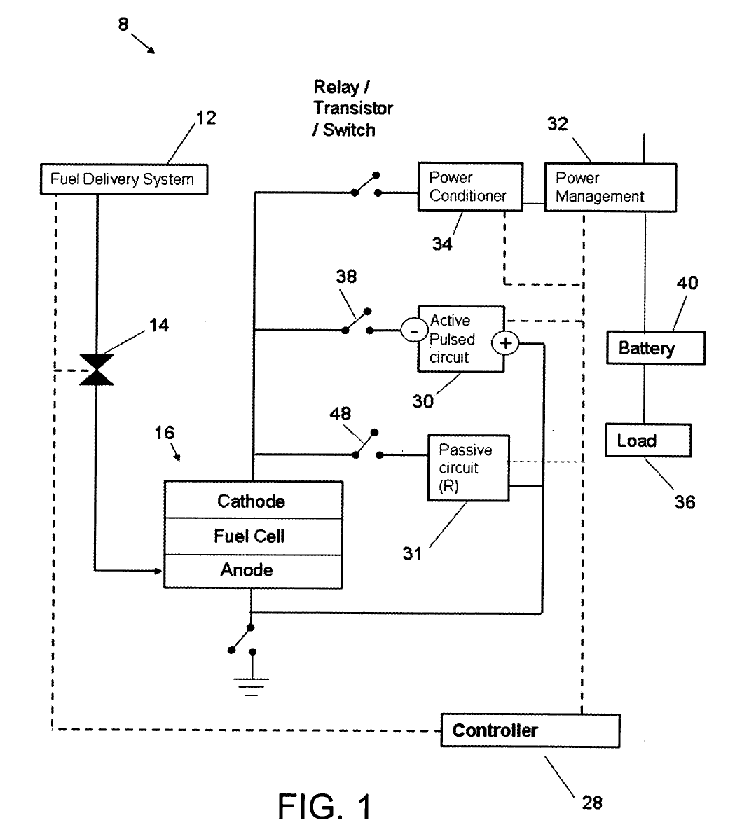

FIG. 1 is a schematic of an embodiment of the system for re-activating a liquid fuel cell anode and MEA. FIG. 1 shows an anode re-activating system 8 including liquid fuel cell 16 and electronic and fuel delivery components. Liquid fuel cell 16 includes an anode layer coupled to an electrolyte layer, coupled to a cathode layer. Fuel is delivered from fuel delivery system 12, which can include an optional fuel pump. The flow of fuel is controlled by throttle valve 14, connected to fuel cell controller 28.

The fuel cell electronics are controlled by controller 28, and include a re-activation active circuit 30 which can be switched in or out by switch 38, and re-activation passive circuit 31 with switch 48, power conditioner 34 directly connected to the fuel cell anode to transfer conditioned power to power management module 32 which routes and delivers fuel cell power to one or both of an optional battery storage 40 or load 36. Optionally the connection to load 36 can be switched off by a load switch as shown. When the load switch is closed in normal fuel cell operation mode, current flows from fuel cell through power conditioner 34 through power management module 32 to the selected destination load. When switches 38 or 48 are closed, the corresponding re-activation circuit is connected to across the fuel cell anode and cathode. The switched re-activation circuit can be an active pulsed circuit (“active mode”) or a passive shorting circuit (“passive mode”). Equivalent structures can perform a combination of the same functions. For example, controller 28 can incorporate the power conditioner and the power management module.

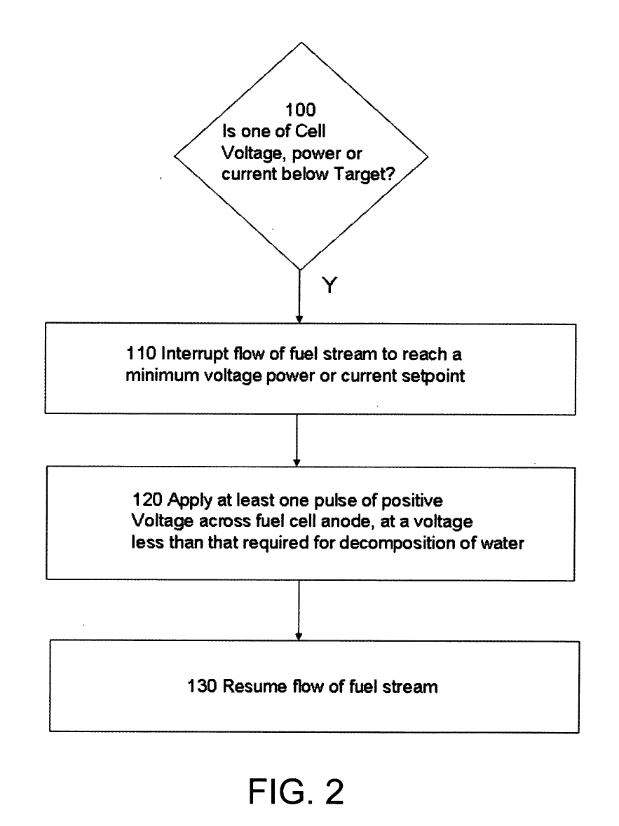

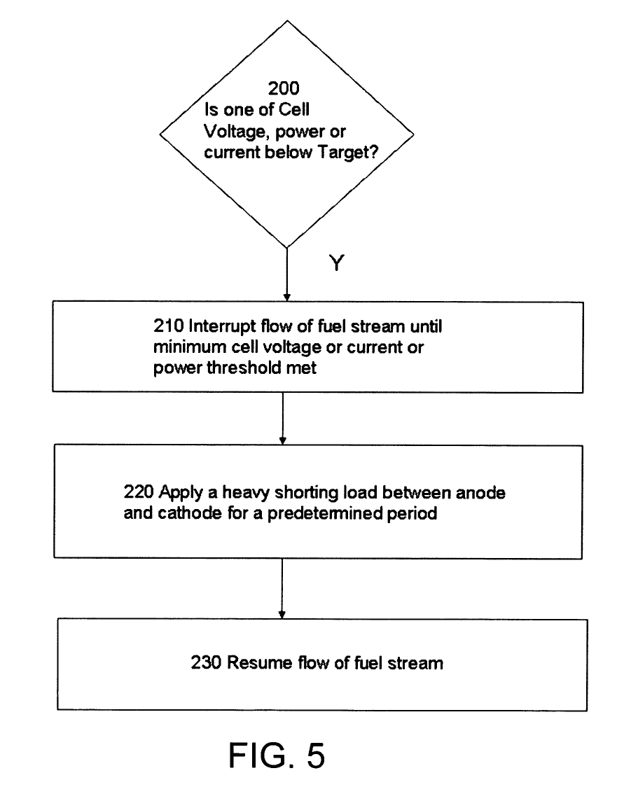

The re-activation circuit can be selected for providing positive anode voltage pulses, or passive short-circuit for a period of time, as detailed in the process flow diagrams depicted in FIGS. 2 and 5.

An embodiment of the active re-activating circuit shows how positive voltage pulses are applied. For the pulsed mode of re-activation, re-activation circuit 30 is connected to system controller 28 and includes a signal generator provided as a control device. The signal generator controls a fast high-power transistor switch, for example a metal oxide silicon field effect transistor (MOSFET) for generating voltage pulses. The MOSFET transistor is electrically connected to the fuel cell anode 22, so that a pulsed variation of the anode potential is produced. Alternatively, embodiments can use other switchable power sources equivalently, such as a charged capacitor or battery supply in a hybrid fuel cell system. The generated variation in anode potential is such that carbon monoxide adsorbed at the anode catalyst can be oxidized.

The positive voltage pulse is equivalent to a net positive potential and can optionally be created by two negative voltages applied to the anode and cathode, but are represented in this example and in the drawing by a negative and positive voltage. Short current or voltage pulses are produced and impressed on the anode. The pulse can in principle be of many desired shapes. For the pulsed variation of the anode potential, a control device for a suitable, fast transistor switch is employed. The transistor switch changes the anode potential to positive values. An external DC voltage source of about 1 V, such as a battery, applied via switch 38, is applied to the cell for a predetermined time.

When the positive voltage pulses are applied to the anode, contaminants adsorbed on the anode catalyst are oxidized and, as a consequence, the cell is re-activated. Since the re-activation takes place considerably faster than the de-activation, the average power of the fuel cell increases. This applies in particular when catalysts with improved CO resistance, such as Pt alloys, are employed. The active pulsed method can be employed for either “wet” re-activation with no or limited fuel interruption, or re-activation with fuel interruption. The preferred method is with fuel interruption.

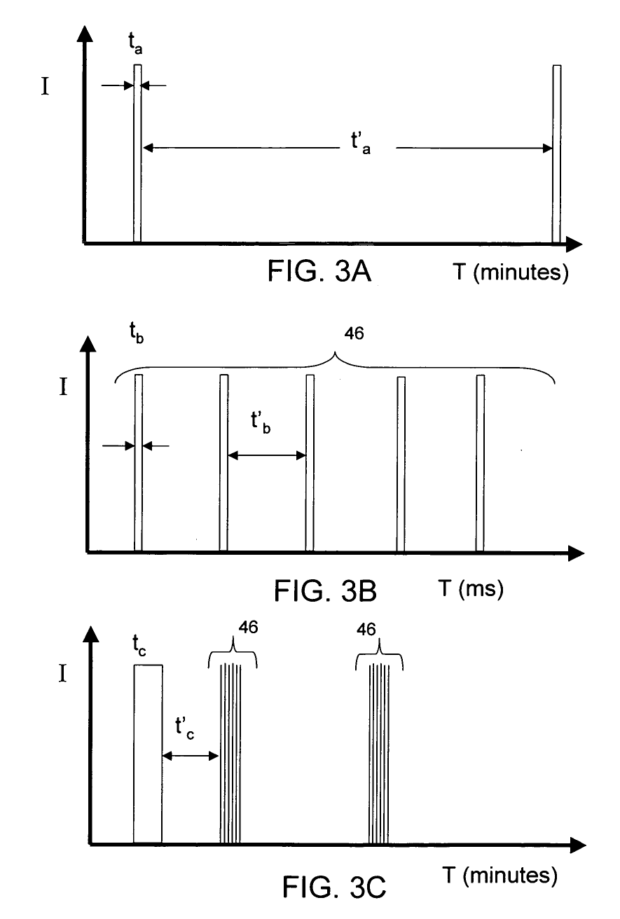

The pulsing method can be operated with a range of intervals between pulses, pulse widths and durations of a pulse train or series. Intervals between pulses are typically in the range between 0.1 second to 2 hours, but are not limited to that range. Pulse width typically ranges between 10 milliseconds and 100 seconds, but is not limited to that range. Preferred pulse characteristics are discussed in FIG. 3 in more detail. The current densities are generally several amperes/square centimeter (A/cm²), such as between 0.01 A/cm² and 5 A/cm².

The power losses of a fuel cell caused by the operation of an active electronic device for generating the voltage or current pulses, as well as the power losses caused by the energy expended for the pulse, are typically about 1%-5% of the power generated by the cell.

An embodiment of the passive or “shorting” re-activating circuit 31 shows how a net positive voltage is applied. This re-activation system is called “passive” since it requires no additional generated power and hence has higher overall system power efficiency than the pulsed mode. For the shorted mode of re-activation, re-activation circuit 30 is connected to system controller 28 and includes a shorting resistor R electrically connected to fuel cell anode (not shown) so that a variation of the anode potential is produced. Preferably, the resistive load of the shorting resistor is between about 0 Ω and about 1.5 Ω. The variation is such that carbon monoxide adsorbed at the anode catalyst can be oxidized.

This electrical connection (heavy load, or shorting) between the anode and cathode when operating in fuel interruption mode can also recover the performance degradation from anode catalyst poisoning. The anode potential increases to close to air electrode potential (as the remaining anode fuel is consumed during fuel interruption), and this higher anode potential can help to remove CO. Then cathode potential decreases (due to cathode air being consumed). This reduced cathode potential converts Pt oxide to Pt and re-activates the cathode electrocatalyst, as similarly happens during the pulsed mode. Passive re-activation consumes less power than active re-activation, but passive re-activation occurs more slowly than active re-activation.

FIG. 2 shows process steps for measuring and triggering an active re-activation process, and is described for the transistor switch embodiment, but equally applies to other power sources. The pulsed re-activation circuit can be triggered by a timed setting in system controller 28, or by feedback of cell voltage reaching a cell voltage set point in Step 100 (this could alternatively be a current or power setpoint). When the cell voltage drops below the set point (representing decreased cell performance due to poisoning), controller 28 instructs valve 14 to reduce or shutoff the fuel flow to fuel cell 16, in step 110, causing cell power to drop until a cell power (or current or voltage) threshold is met representing a near fuel interruption mode. This second threshold is selected depending on the application, and can also be proportional to the rate of change of the cell voltage. At this step, re-activation switch 38 is closed to connect circuit 30, and optional connection to the battery (dashed line) or alternate power source and configure the system for re-activation. Circuit 30 can optionally be coupled to ground, when required with an external power source. Upon the cell power being reduced at or below the threshold, controller 28 signals the pulse generator in re-activation circuit 30 to send a selected pulse or series of pulses to the transistor switch, and a resulting positive voltage pulse or series of pulses to the anode of the fuel cell. When the re-activation cycle is complete, as programmed in the system controller 28, switch 38 is opened and fuel valve 14 is opened to provide fuel delivery for normal fuel cell mode operation. In an alternate embodiment, the pulse can be applied simultaneously with the fuel interruption. Specifically for small fuel cells operating with microfluidic fuel volumes, the interruption is near instantaneous.

FIG. 3 is a graphical representation of a series of positive voltage pulses applied by the active electronic re-activating system. FIG. 3A shows long infrequent pulses. FIG. 3B shows short and frequent intense pulses. FIG. 3C shows a combination of long and short pulses. In FIG. 3, tₓ represents the pulse width and t′_{X} represents the pulse interval. In FIG. 3A, a preferred example of long infrequent pulses is shown, for example tₐ=1 second and t′ₐ=5 min. A shorter pulse series 46 is shown in FIG. 3B where the timescale has been reduced to milliseconds, and a preferred example is t_{b}=100 microseconds and t′_{b}=5 milliseconds. A third hybrid mode is illustrated in FIG. 3C, showing a shorter pulse series 46 following a long pulse, separated by an interval t′_{c}.

If a fuel cell is operated under constant load at heavy duty (defined as 50% or more of rated fuel cell system power), then the active re-activation mode and method is preferred. In cases of load changes, a corresponding variation of the pulse characteristics is preferred.

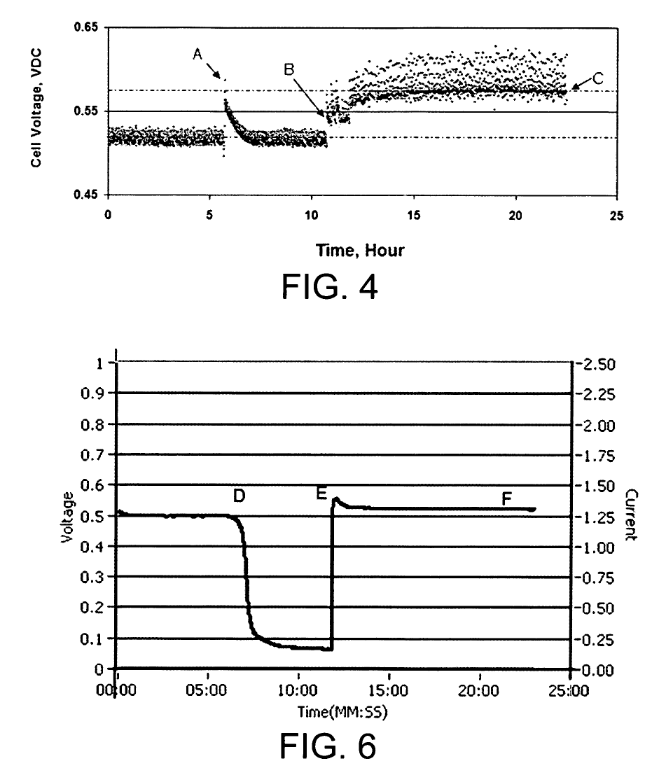

FIG. 4 is a graph of cell voltage as a function of time, showing the effect of active re-activation of the fuel cell anode for the case of a formic acid fuel cell using a Pt alloy catalyst, and measured in repeated experiments as shown by the experimental scatter. The fuel cell is operated at a constant current with a cell temperature of 30° C. At time A, the applied voltage pulses have a magnitude of 1.6 V, that is, greater than 1.5 V. The current at time A is a 25 A re-activation current. After time A, the cell demonstrates a short term increase in cell voltage and then returns to prior cell voltage. At time B, the applied voltage pulses are below 1.5 V and above 1 V, at a re-activation current density of 0.8 A/cm² (4 A over an area of 5 cm²), resulting in increased recovered average cell voltage C. A preferred positive voltage range is between about 0.9 V and about 1.5 V.

FIG. 5 shows process steps of the passive re-activation process. As previously, the process can be triggered by timed setting or feedback of the cell voltage (or power or current) as shown in Step 200. When triggered, controller 28 shuts off or reduces fuel flow to fuel cell 16 in step 210, causing cell power (or current or voltage) to drop until a cell power (or current or voltage) threshold is met representing a near fuel interruption mode. Circuit 31 can be a shorting resistor or resistive load connected between the anode and cathode of the fuel cell to ground. Upon the cell power being reduced at or below the threshold, controller 28 closes switch 48 and a shorting or resistive load is applied between the anode and the cathode of the fuel cell in step 220. The interposing of the resistive load can act in one of two ways, depending on the configuration of the fuel cell system. The first would be to increase the anode potential to a voltage magnitude about equal to that of the cathode. The second would be to decrease the cathode potential to a voltage magnitude about equal to that of the anode potential. When the passive re-activation duration is complete, as programmed in the system controller 28, switch 48 is opened and fuel valve 14 is opened to provide fuel delivery for normal fuel cell mode operation in step 230.

FIG. 6 shows a graph of cell voltage during fuel interruption and after passive re-activation of the fuel cell anode in a constant resistance mode for a formic acid fuel cell in a constant current mode of 1 A and a cell temperature of 30° C. Controller 28 shuts off fuel valve 14 at time D and two 0.22 Ω shorting resistors were connected in series by the re-activation circuit 30. Cell voltage drops and continues in fuel interruption mode for approximately 4 minutes before fuel valve 14 is reopened at time E. Following fuel interruption, the recovered cell voltage stabilizes to a higher cell voltage as shown at F, increasing by 30 mV or approximately 6%. This result demonstrates that fuel interruption with passive electrical re-activation, produces useful improvement.

The re-activation system and method can operate in either active or passive re-activation modes or a hybrid mode combining active and passive processing to re-activate the anode and cathode electrocatalyst layers of the fuel cell. Selecting the re-activating mode can be done by system controller 28 based on whether the duty cycle is heavy duty or light duty, as the degree of fuel cell use will dictate the extent of electro-catalyst poisoning. For example, in a formic acid fuel cell using a Pt catalyst, a heavy duty cycle can be defined as 50% or more of the rated fuel cell system power (for an application) and light duty cycles can be defined as less than 50% of rated fuel cell system power.

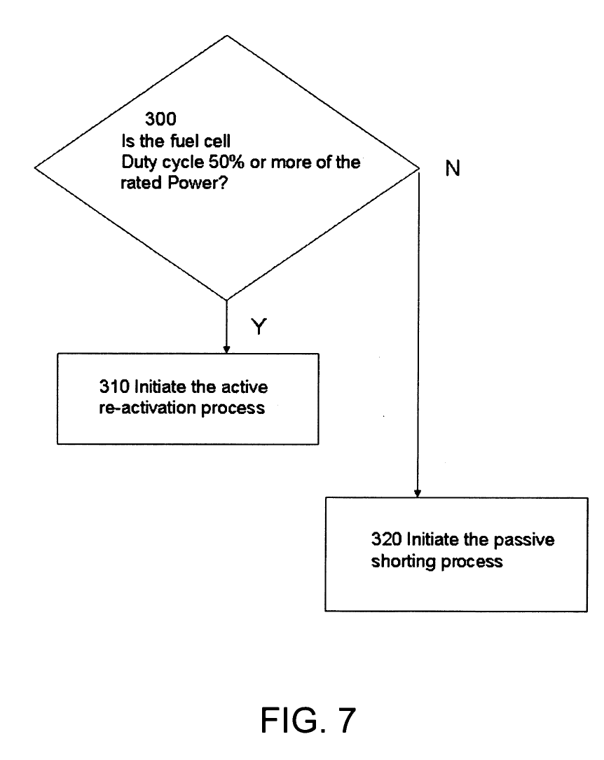

FIG. 7 shows a control process to select the sequence of active or passive re-activation sequences. System controller 28 determines whether the fuel cell duty cycle is operating at 50% or more of rated power. If yes, then in step 310, the active re-activation process of FIG. 2 is selected by controller 28. If no, then in step 320, the passive re-activation process of FIG.5 is selected by controller 28. The modes can be changed on an ongoing basis by controller 28, and can include a transition delay time between modes for efficient operation.

While the embodiments thus far show a single fuel cell, multiple fuel cells connected to a common load could be configured with one re-activating circuit to re-activate the multiple cells simultaneously. Alternatively, multiple cells could be connected to discrete multiple re-activation circuits 30 to be individually re-activated.

The fuel cell re-activating systems described herein, demonstrate benefits over previous systems. First, the process demonstrates high efficiency and low power consumption. With a pulsed powered method a low re-activation current density (<0.5 A/cm²) is achieved, compared with approximately 4 A/cm² in previous solutions. Cell voltage recovery is significant. Also, fuel consumption is reduced, compared with approximately 100 mWh/cm² fuel consumption in known solutions for liquid fuel interruption (not gas H₂). Re-activation voltage is controlled to prevent anode corrosion in the case of formic acid fuel. Another benefit is that substantially no pressure difference builds up between the anode and the cathode as the CO₂ production rate is low. In addition, the electronic circuits required are reliable, small and economical, without requiring, for example, super-capacitors to generate high current.

While particular elements, embodiments and applications of the present invention have been shown and described, it will be understood, of course, that the invention is not limited thereto since modifications can be made by those skilled in the art without departing from the scope of the present invention, particularly in light of the foregoing teachings.

What is claimed is:

1. A method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at said anode, the method comprising:
(a) intermittently applying positive voltage electrical pulse across said anode, said positive voltage having a magnitude less than that required for decomposition of water;
(b) interrupting flow of said fuel stream to said anode; and
(c) interposing a resistive load between said anode and said cathode while fuel stream flow to said anode is interrupted, said resistive load increasing voltage potential at said anode to less than that required for oxidation of carbon.

2. The method of claim 1, wherein said positive voltage pulse is applied while fuel stream flow to said anode is interrupted.

3. The method of claim 1, wherein said positive voltage electrical pulse has a magnitude between about 0.9 V and about 1.5 V on said anode.

4. The method of claim 1, wherein said positive voltage electrical pulse has a current density associated therewith having a magnitude no greater than about 0.5 A/cm².

5. The method of claim 1, wherein said positive voltage electrical pulse is applied at intervals of at least 0.1 seconds to 2 hours.

6. The method of claim 5, wherein said positive voltage electrical pulse is applied at intervals of about 5 minutes.

7. The method of claim 1, wherein said positive voltage electrical pulse is applied for a duration of between 1 millisecond and 100 seconds.

8. The method of claim 7, wherein said positive voltage electrical pulse is applied for a duration of between 0.5 seconds and 1.5 seconds.

9. The method of claim 1, wherein said positive voltage electrical pulse is applied at intervals of about 100 milliseconds and said positive voltage electrical pulse is applied for a duration of about 5 milliseconds.

10. The method of claim 1, wherein said positive voltage electrical pulse is derived from electrical power generated by said fuel cell.

11. The method of claim 1, wherein said positive voltage electrical pulse has a positive voltage sufficient to oxidize carbon monoxide.

12. The method of claim 11, wherein said positive voltage at said anode has a magnitude between about 0.9 V and about 1.5 V.

13. The method of claim 1, wherein interposing said resistive load increases said anode potential to a voltage magnitude about equal to that of said cathode.

14. The method of claim 1, wherein interposing said resistive load decreases said cathode potential to a voltage magnitude about equal to that of said anode potential.

15. The method of claim 1, wherein said resistive load is between about 0 Ω and about 1.5 Ω.

16. The method of claim 1, wherein said fuel stream comprises formic acid.

17. A method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at said anode, the method comprising intermittently applying positive voltage electrical pulse across said anode while fuel stream flow to said anode is interrupted, said positive voltage less than that required for decomposition of water.

18. The method of claim 17, further comprising a step of interrupting flow of said fuel stream to said anode and wherein said positive voltage electrical pulse is applied across said anode while fuel stream flow to said anode is interrupted.

19. The method of claim 17, wherein said positive voltage electrical pulse has a magnitude between about 0.9 V and about 1.5 V.

20. The method of claim 17, wherein said positive voltage electrical pulse has a current density associated therewith having a magnitude no greater than about 0.5 A/cm².

21. The method of claim 17, wherein said positive voltage electrical pulse is applied at intervals of at least 0.1 seconds to 2 hours.

22. The method of claim 21, wherein said positive voltage electrical pulse is applied at intervals of about 5 minutes.

23. The method of claim 17, wherein said positive voltage electrical pulse is applied for a duration between 1 millisecond and 100 seconds.

24. The method of claim 23, wherein said positive voltage electrical pulse is applied for a duration between 0.5 seconds and 1.5 seconds.

25. The method of claim 17, wherein said positive voltage electrical pulse is applied at intervals of about 100 milliseconds and said positive voltage electrical pulse is applied for a duration of about 5 milliseconds.

26. The method of claim 17, wherein said positive voltage electrical pulse is derived from electrical power generated by said fuel cell.

27. The method of claim 17, wherein said positive voltage electrical pulse has a positive voltage sufficient to oxidize carbon monoxide.

28. The method of claim 27, wherein said positive voltage at said anode has a magnitude between about 0.9 V and about 1.5 V.

29. The method of claim 17, wherein said fuel stream comprises formic acid.

30. A method for counteracting performance deterioration in an electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween, wherein an aqueous fuel stream is directed to and oxidizable at said anode, the method comprising:
(a) interrupting flow of said fuel stream to said anode; and
(b) interposing a resistive load between said anode and said cathode while fuel stream flow to said anode is interrupted, said resistive load increasing voltage potential at said anode to less than that required for oxidation of carbon.

31. The method of claim 30, wherein interposing said resistive load increases said anode potential to a voltage magnitude about equal to that of said cathode.

32. The method of claim 30, wherein interposing said resistive load decreases said cathode potential to a voltage magnitude about equal to that of said anode potential.

33. The method of claim 30, wherein said resistive load is between about 0 Ω and about 1.5 Ω.

34. The method of claim 30, wherein said fuel stream comprises formic acid.

35. An electric power generation system comprising:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at said anode;
(c) a flow control mechanism capable of interrupting flow of said fuel stream to said anode;
(d) an electrical circuit capable of intermittently applying positive voltage electrical pulse across said anode, said positive voltage less than that required for decomposition of water; and
(e) a resistive load interposable between said anode and said cathode while fuel stream flow to said anode is interrupted, said resistive load increasing voltage potential at said anode to less than that required for oxidation of carbon.

36. The system of claim 35 wherein said flow control mechanism is a valve.

37. The system of claim 35 wherein said electrical circuit is capable of intermittently applying positive voltage electrical pulse across said anode while fuel stream flow to said anode is interrupted.

38. The system of claim 35, wherein said positive voltage electrical pulse has a magnitude between about 0.9 V and about 1.5 V.

39. The system of claim 35, wherein said positive voltage electrical pulse has a current density associated therewith having a magnitude no greater than about 0.5 A/cm².

40. The system of claim 35, wherein said positive voltage electrical pulse is applied at intervals of at least 0.1 seconds to 2 hours.

41. The system of claim 40, wherein said positive voltage electrical pulse is applied at intervals of about 5 minutes.

42. The system of claim 35, wherein said positive voltage electrical pulse is applied for a duration of between 1 millisecond and 100 seconds.

43. The system of claim 42, wherein said positive voltage electrical pulse is applied for a duration of between 0.5 seconds and 1.5 seconds.

44. The system of claim 35, wherein said positive voltage electrical pulse is applied at intervals of about 100 milliseconds and said positive voltage electrical pulse is applied for a duration of about 5 milliseconds.

45. The system of claim 35, wherein said positive voltage electrical pulse is derived from electrical power generated by said fuel cell.

46. The system of claim 35, wherein said positive voltage electrical pulse has a positive voltage sufficient to oxidize carbon monoxide.

47. The system of claim 46, wherein said positive voltage at said anode has a magnitude between about 0.9 V and about 1.5 V.

48. The system of claim 35, wherein said resistive load of said resistor increases said anode potential to a voltage magnitude about equal to that of said cathode.

49. The system of claim 35, wherein said resistive load of said resistor decreases said cathode potential to a voltage magnitude about equal to that of said anode potential.

50. The system of claim 35, wherein said resistive load of said resistor is between about 0 Ω and about 1.5 Ω.

51. The system of claim 35, wherein said fuel stream comprises formic acid.

52. An electric power generation system comprising:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at said anode;
(c) a flow control mechanism capable of interrupting flow of said fuel stream to said anode; and
(d) an electrical circuit capable of intermittently applying positive voltage electrical pulse across said anode, said positive voltage less than that required for decomposition of water.

53. The system of claim 52 wherein said flow control mechanism is a valve.

54. The system of claim 52 wherein said electrical circuit is capable of intermittently applying positive voltage electrical pulse across said anode while said fuel stream flow to said anode is interrupted.

55. The system of claim 52, wherein said positive voltage electrical pulse has a magnitude between about 0.9 V and about 1.5 V.

56. The system of claim 52, wherein said positive voltage electrical pulse has a current density associated therewith having a magnitude no greater than about 0.5 A/cm².

57. The system of claim 52, wherein said positive voltage electrical pulse is applied at intervals of at least 0.1 seconds to 2 hours.

58. The system of claim 57, wherein said positive voltage electrical pulse is applied at intervals of about 5 minutes.

59. The system of claim 52, wherein said positive voltage electrical pulse is applied for a duration of between 1 millisecond and 100 seconds.

60. The system of claim 59, wherein said positive voltage electrical pulse is applied for a duration of between 0.5 seconds and 1.5 seconds.

61. The system of claim 52, wherein said positive voltage electrical pulse is applied at intervals of about 100 milliseconds and said positive voltage electrical pulse is applied for a duration of about 5 milliseconds.

62. The system of claim 52, wherein said positive voltage electrical pulse is derived from electrical power generated by said fuel cell.

63. The system of claim 52, wherein said electrical pulse has a positive voltage sufficient to oxidize carbon monoxide.

64. The system of claim 63, wherein said positive voltage at said anode has a magnitude between about 0.9 V and about 1.5 V.

65. The system of claim 52, wherein said fuel stream comprises formic acid.

66. An electric power generation system comprising:
(a) at least one electrochemical fuel cell comprising: (i) an anode comprising carbon and having an anode electrocatalyst associated therewith, (ii) a cathode having a cathode electrocatalyst associated therewith, and (iii) a proton exchange membrane interposed therebetween,
(b) an aqueous fuel stream directed to and oxidizable at said anode;
(c) a flow control mechanism capable of interrupting flow of said fuel stream to said anode; and
(d) a resistive load interposable between said anode and said cathode while fuel stream flow to said anode is interrupted, said resistive load increasing voltage potential at said anode to less than that required for oxidation of carbon.

67. The system of claim 66 wherein said flow control mechanism is a valve.

68. The system of claim 66, wherein said resistive load of said resistor increases said anode potential to a voltage magnitude about equal to that of said cathode.

69. The system of claim 66, wherein said resistive load of said resistor decreases said cathode potential to a voltage magnitude about equal to that of said anode potential.

70. The system of claim 66, wherein said resistive load of said resistor is between about 0 Ω and about 1.5 Ω.

71. The system of claim 66, wherein said fuel stream comprises formic acid.
